(19) United States
(12) Patent Application Publication
(10) Pub. No.: US 2025/0015687 A1
(43) Pub. Date: Jan. 9, 2025

(54) SYSTEM AND PROCESS FOR ASSEMBLING A STATOR OR ROTOR WINDING

(71) Applicant: Tecnomatic S.p.A., Corropoli (Teramo) (IT)

(72) Inventors: Giovanni RUGGIERI, Corropoli (Teramo) (IT); Maurilio MICUCCI, Corropoli (Teramo) (IT); Giuseppe RANALLI, Corropoli (Teramo) (IT)

(21) Appl. No.: 18/276,092

(22) PCT Filed: Mar. 7, 2023
(86) PCT No.: PCT/IB2023/052123

§ 371 Date: Aug. 7, 2023

(30) Foreign Application Priority Data
Mar. 29, 2022 (IT) 102022000006170

(51) Int. Cl. H02K 15/06; H02K 15/02

(52) U.S. Cl. CPC H02K 15/064; H02K 15/024; H02K 2215/00

(57) ABSTRACT

An assembly and insertion system for assembling and inserting, into a stator pack, a winding having one or more layers of basic conductors is provided. The assembly and insertion system has a circumferential containment of the basic conductors with a set of spaces or slots, and one or more removable inserters of the basic conductors into the circumferential containment, and elements for rotating the circumferential containment about the winding axis. A rotary table is configured to rotate about a table axis to bring the circumferential containment from an assembly position to an insertion position for insertion into the stator pack. The winding is assembled on one side of the rotary table while feeding elements of the stator pack and relative introduction elements of the winding into the stator pack at the insertion position act on the opposite side. A process for assembling and inserting a winding into a stator pack is also provided.

The present invention relates to a system and a process for assembling a stator or rotor winding.

### BACKGROUND ART

It is generally known to make stators or rotors of electric machines, such as generators or electric motors, e.g., for applications on hybrid electric vehicles (HEVs), in which the stator or rotor winding consists of a plurality of bent bar conductors and variously interconnected to one another so as to realize electric windings also known as “bar windings”. Said bent bar conductors are also referred to as “hairpin conductors” or simply “hairpins”. The bar windings can be constituted by one or more groups of concentric windings, sometimes known as “crowns”, each group of windings being already a winding per se (“winding sets”).

In particular, windings with hairpins having a circular cross-section (also said “rounded-wire conductors”) or a rectangular cross-section, or even conductors with a variable cross-section geometry along the length (e.g., round conductors made rectangular in the part housed in the slot) are known in the prior art. In this regard, “rectangular” or “square” conductor wire means, in this description, a wire having four substantially flat sides, each joined to the adjacent sides, typically by a rounded edge. Bar conductors having a trapezoidal-shaped cross-section are known.

The aforesaid bar conductors are usually preformed by bending them in a “U”- or a “P” shape, starting from straight bar conductors. Patent U.S. Pat. No. 7,480,987 describes an example of a method for preforming straight bar conductors to form hairpins. “U” or “P”-shaped preformed conductors, often also referred to as “preformed basic conductors” in the technical field, typically have two adjacent legs, of equal or different length, each provided with a free end portion and an opposite end portion, which is connected to the other leg by means of a bridge-like connecting portion. Since the end portions protrude when they are inserted into the rotor or stator, they will henceforth be referred to as the “free protruding portion” and “opposite protruding connected portion”. The protruding connected portion can also be referred to as the “head portion” or “bridge-like connected portions”. The whole of the “head portions” of the legs of the same hairpin forms the so-called “bridge-like connection”.

With reference to FIG. 1(a), a hairpin 255 is preformed starting from a linear conductor (not shown) by bending it to form a first leg 255a with a corresponding free protruding end portion 255aE and a second leg 255b with a corresponding free protruding end portion 255bE. The bending shape forms, at the same time, a bridge-like connection 255c between the two legs 255a, 255b. The preformed hairpin, in this example, is in the shape of a flattened “U”. To form a stator of an electric machine, for example, it is known to subject the “U”- or “P”-shaped preformed hairpins to two different types of twisting.

A stator or rotor core of a radial magnetic flux electric machine is substantially a ring having two flat faces and two cylindrical surfaces, having generators perpendicular to the two flat faces parallel to the rotation axis of the rotor of the electric machine. The radial, circumferential and axial directions hereinafter refer to the latter axis, unless otherwise specified. One of the two cylindrical surfaces is adjacent, at least in part, to the air gap of the electric machine, to which said stator or rotor belongs and defines a set of slots in which the straight parts of the winding are housed. The two flat surfaces are divided into the insertion surface or side and the surface or side opposite to the insertion side. The parts of the winding which protrude from said core are referred to as heads. The ends of the free portions of the conductors, which are mainly subject to welding, belong to the head protruding from the side opposite to the insertion side. If protruding portions connected in a bridge-like manner to the legs inserted into the stator slots are present in the winding, they belong to the head protruding from the insertion side. The portions protruding from the insertion side, either free or connected in a bridge-like manner, are indicated hereafter as portions protruding from the insertion side.

The stator or rotor core region between a slot and an adjacent one is referred to as tooth. The number of teeth is equal to the number of slots. The connecting part of the teeth of the core, which also defines a portion of each slot and is located relative thereto on the side opposite to the slot opening on the air gap of the machine, is referred to as a yoke.

The slot can be divided into an array of positions in each of which a leg of a basic conductor can be placed. The conductors housed in the same radial position of the slots define a so-called winding layer.

In a first type of twisting, also referred to as “insertion side twisting”, the preformed basic conductors are appropriately inserted into corresponding radially aligned pockets or “slots”, which are provided in a twisting device adapted to deform such conductors after insertion. The twisting device is substantially used to “spread” the legs of the “U” or “P” shape so that the two legs of each conductor, after having extracted the latter from the device, can then be inserted into a corresponding pair of slots of a stator core, which are mutually angularly offset by a predetermined distance, substantially equal to the angular distance between the slots in which the legs are then inserted, and radially spaced apart by the radial distance between the slot positions occupied by the legs, respectively.

Starting from a preformed hairpin, for example, but not exclusively, as shown in FIG. 1(a), a hairpin of suitable shape for its insertion into the stator (or rotor) is formed by spreading the legs 255a, 255b and shaping the bridge-like connection 255c, e.g., to obtain the shape in FIG. 1(b). Reference numeral 255p indicates the pitch of the hairpin, i.e., the linear distance or the angular distance, or the distance in terms of slot pitches, between the legs. It is worth noting that in this case, the central top 255c2 of the formed hairpin is the basic conductor in which the section of the conductor is subjected to a 180° rotation with respect to the median surface of the hairpin (the surface which passes inside the hairpin and includes the two legs). Such a rotation is useful in some layered hairpins, which will be defined hereafter to the end of transposing the layers (exchange of slot positions) thus reducing eddy currents circulating through the ends of the layers when they are welded together, compared with the case in which the same layers run parallel without exchanging slot position in the transition from one leg to the other.

The patent application published under US 2009/0178270 discloses an example of a twisting method from the insertion side for the twisting, at a uniform pitch, of the preformed bar conductors after having inserted them into the pockets of a twisting device, in which the hairpins have a rectangular cross-section.

According to the prior art and with reference to FIG. 2, the hairpins can also be obtained by molding, a process in which a straight conductor is pressed against a backing member in a punch-and-die type system. FIG. 2(a) shows such a molded conductor; it does not have a cross-section, which rotates with respect to the median surface of the hairpin.

This molded hairpin or even a preformed and spread hairpin, obtained as described above, can be subjected to the so-called “welding side twisting”, in which case it is possible to introduce a “step-like” shape of the protruding portions of the legs 255a and 255b, in which, for example, the leg 255a has a first straight portion 255a1, a step-like portion 255a2 and a second straight portion 255a3 (substantially corresponding to portion 255aE in FIG. 1), as in FIG. 2(b). With reference to FIG. 3, the shape of the protruding portion on the insertion side, i.e., of the bridge-like connection 255c, for a molded hairpin, can comprise three portions 255c1, 255c3, and 255c2 starting from the connection to the second leg 255b and ending at the connection to the first leg 255a (hidden from view in FIG. 3). The portion 255c1 has a main extension direction B and a curvature radius RB, the portion 255c3 has a main extension direction A and a curvature radius RA, the portion 255c2 has a main extension direction C (and possibly a curvature thereof, not indicated). Hereafter, the portion 255c2 is referred to as the “layer change bend”; indeed, by virtue of it, the head and leg portions of the hairpins are on different layers when they are inserted into the respective slots of the stator pack. Reference α1 indicates the angle between the directions A and C, reference α2 indicates the angle between directions A and B and reference α3 indicates the angle between directions B and C, equal to the sum of the angles α1 and α2. This is only one of the final possible shapes of a hairpin, all other shapes with different portions and conformations of both the bridge-like portion and the legs can be used with the apparatus and a method according to the present description.

There are also conductors defined as “reverse” conductors (not shown), and they are hairpins with a bending direction in the bridge-like connection opposite to that of most hairpins that form the same winding. These are used to go from the last layer of one crown to the first layer of the next crown.

Furthermore and with reference to FIG. 4A, there is a layered (“stranded”) hairpin with a reversal of the cross-section at the bending point (FIG. 4A(a)), which causes the exchange of the position occupied by the layers. As can be seen from the type of hatching of the cross-section in FIG. 4A(a), by virtue of said reversal or exchange of position, the upper layer in the pair of layers in the left slot is below the other one in the right slot. In another hairpin shape, the transposition can be continuous along the hairpin portions housed in the slot (FIG. 4A(b); U.S. Pat. No. 3,837,072). The variant shown in FIG. 4B is a layered hairpin free from reversal, shown in patent U.S. Pat. No. 8,552,611 B2. FIG. 4C (taken from FIG. 6 of Patent U.S. Pat. No. 6,894,417 B2) shows the variants of the arrangement of the legs of the layered hairpins in a double-crown winding in different positions in the slot. Reference letters A and B indicate the crown to which the legs (belonging to different hairpins) shown in the slot belong.

Furthermore, there are conductors referred to as “I-pins”, i.e., a conductor to be housed in a single slot and, when in the slot, having the portions with free ends protruding from both flat faces of the stator core. FIG. 4D shows an example of an I-pin, which does not necessarily have to have all the direction changes shown, it can also have none, and be bent from the output side of an assembly drum of the hairpin winding. The ends of the I-pin can be welded to ends of other conductors protruding from the slots or to third-party elements (e.g., bus bars, eyelets) or they can serve as phase terminals. The portions can be subject to the “welding side” type bending. An example of an I-pin can be found in the conductors indicated with references 81-83 in document U.S. Pat. No. 7,622,843B2. “W-shaped conductors” are also known, see for example, again, patent U.S. Pat. No. 7,622,843 B2 and FIG. 4E. A W-shaped conductor can be formed by welding a molded hairpin with one I-pin or by welding a fourth conductor to three I-pins. Once again, the W-pin does not necessarily have to have all the direction changes shown, it can also have none, and be bent from the output side of the assembly drum of the hairpin winding.

With illustrative reference to FIG. 4F (obtained from U.S. Pat. No. 10,749,399B2), there is also the so-called “inversion hairpin,” i.e., a hairpin which can be formed by spreading the legs (not with the insertion-side twisting method described above) or molded with “press and die” systems, characterized in that the legs in their respective slots occupy the same radial position, i.e., belong to the same layer. Therefore, its ends will be bent in the same direction on the twisting side. Actually, the protruding portions on the side of the bridge-like connection can be bent in the same tangential direction or can take the V shape. At least two layer-change bends can be required on the connecting portion.

Finally, there are hairpin pairs whose homologous legs belong to different layers (FIG. 4G) or to the same layer (FIG. 4H) and they are configured and sized to be overlapping.

Hereafter, all the hairpin types, as well as the I-pins and the W-pins will be included in the definition of “basic conductors”.

After having been subjected to the first type of twisting or after having been molded, the basic conductors are typically pre-assembled in a winding set, as mentioned above. The pre-assembly apparatus will have a set of slots, generally in number equal to the slots of the stator associated with the winding, into which the legs of each hairpin are to be inserted, and it will generally be different from the twisting device.

The winding set is then inserted in bulk into the slots of the stator core through a first side thereof (so-called “insertion side” or “insertion face”) with the respective free portions protruding from a second side of the core (so-called “welding side” or “connection side” or “welding face” or “escaping face”) opposite to the first side.

Based on the specific winding pattern to be achieved, the free portions of the basic conductors protruding from the side opposite to the insertion side can thus be subjected to a second type of twisting, also referred to as “twisting from the welding side”, e.g., after having been inserted into pockets made in an appropriate twisting fixture. Here, the twisting fixture has the purpose of bending or twisting the free portions of the conductors to appropriately shape such free portions and thus allowing the appropriate electric connections to be achieved between the conductors to complete the winding. Patent application published under number US 2009/0302705 describes an example of a twisting method from the welding side of the type discussed above.

Assembly systems of electric winding for stators and/or rotors are known. Systems for transferring the winding and inserting it into a stator pack are also known.

With reference to FIG. 5A, Odawara's patent application US2019/0190359 describes a system of forming basic conductors and subsequently assembling them into a winding, which is then inserted into the stator, within a single equipment. The Odawara's application mainly describes the basic conductor forming section, and not the winding assembly and insertion section. However, for the latter, it mentions “guiding means”, which are shown for example in FIG. 24A of Odawara's application with reference numeral 112, which is reproduced in this description as FIG. 5A. The Odawara's application describes the following parts:
the in-line forming (albeit with partial rotations of some elements) of the basic conductors;
the sliding guide means 112;
the radial approach of the basic conductors 175; and
the fact that the drive gear 123 of the cylinder 900 has a larger diameter than the latter.

Furthermore, with reference to Odawara's FIG. 29 (FIG. 5B of the present description), it is apparent that the gear mechanism 123 is such as to ensure the rotation precision of the drum by the servomotor (see paragraph 205 of the mentioned application) and thus is essential to Odawara's solution.

Furthermore, the blade movement mechanism 108 of the cylinder has a rotary axis 121, which sets the cams 130 in motion, and which must be axially actuated by acting on another element 129 connected to the axis 121, and not on the wheel 123 (FIG. 31, shown here as FIG. 5C). The wheel 123 and the ring gear 135 are adapted to extract the winding and thus must have a larger radius than the drum and blades, despite being arranged in axis. Said mechanism requires the insertion of the hairpins in the radial direction.

Indeed, in Odawara's patent, the insertion system into the stator requires a thrust ring gear 135, as shown in the corresponding FIG. 34 and FIG. 5D of the present description.

This overall configuration has several disadvantages, including that the hairpin insertion is performed with a movement approaching the drum with radial and circumferential components. The co-presence of such two movements makes a confining system of the first leg (non-gripped leg) of the hairpin, which can keep up with an excessively high hairpin forming cadence (e.g., 1.5 s), extremely difficult. Furthermore, in the prior art, there is low accuracy of insertion of the hairpin legs into the assembly drum due to the type of movement thereof (in some cases with both radial and circumferential movement). It is also worth noting that in the prior art, there is a high possibility of undesired leg movement in the drum slots (with possible escaping) because Odawara's guide must remain at a distance from the drum (at least temporarily) for the radial insertion of the basic conductor to be possible. Even adding standard confinement, it would be necessary to complicate the rest of the apparatus to preserve the aforesaid movement.

Application ITRM20100371A1 describes a twisting apparatus, comprising a rotary table adapted to move a twisting device between various work stations and, in particular, between a preformed basic conductor loading station, a subsequent special conductor loading station, a twisting station, and an extraction station. The conductors treated by this apparatus are indeed those that are pre-formed or “P”-shaped, as shown above. In any case, these conductors are formed and extracted from the apparatus and only then inserted into a stator pack to form a winding. The insertion is mentioned but not covered in the apparatus described by that patent document, which indeed does not explain the methods. The apparatus is not adapted to form the winding outside the stator pack and then insert the entire winding into the stator pack.

Application U.S. Pat. No. 20,092,65909A1 describes an apparatus in which pre-formed basic conductors can also be twisted all together and then extracted all together for later insertion into the stator pack. This extraction is done by vertically pushing the conductors from the side of their free legs. However, this thrusting and pulling are very complicated and time-consuming, requiring a gripping apparatus, which comprises a set of double fingers equal in number to the slots, stabilizing plates, and other elements all rotated to trap the hairpin legs in a defined position for the insertion into the stator. The gripping apparatus is then moved to the same side as the extraction and lowered above the stator. But this operation is not the last, because the winding still needs to be made to go up again to release the gripping apparatus and in particular the aforesaid fingers. In this manner, the winding remains high above the stator input plane, and additional thrusting means from above are required to complete the insertion. As a result, although U.S. Pat. No. 20,092,65909A1 describes an assembly and an in-stator insertion in the same apparatus, many complicated, time-consuming, costly, and material-intensive means are needed, and many different operating steps are required, and the winding hairpins are not well-calibrated, not to mention that the windings that can be treated are only those that can be made by a simultaneous twisting, which is only a subset of the possible windings.

The need is felt to assemble the entire winding on one system, with no limitations with respect to the type of assembly, and then easily and reliably insert it into the stator pack, without complicated and expensive mechanisms, pursuing the cycle time and accuracy specifications, which are increasingly stringent nowadays.

### Purpose and Object of the Invention

It is an object of the present invention to provide a process and system for assembling a stator or rotor winding which solves the problems and overcomes the drawbacks of the prior art, in all or part.

It is an object of the present invention to provide a process and a system for assembling a stator or rotor winding according to the appended claims.

### DETAILED DESCRIPTION OF EXAMPLES OF PREFERRED EMBODIMENTS OF THE INVENTION

### List of Figures

The invention will now be described by way of non-limiting example, with particular reference to the figures of the accompanying drawings, in which:

FIG. 1 shows a flattened “U”-shaped preformed hairpin in (a) and a formed hairpin in (b), according to the prior art;

FIG. 2 shows in (a) molded conductor and in (b) a conductor after having been subjected to twisting on the welding side;

FIG. 3 shows a top view of the hairpin in 2(a), according to the prior art;

FIG. 4A shows a layered (“stranded”) hairpin with cross-section reversal at the bending point in (a) and with continuous transposition along the hairpin portions housed in a slot in (b), according to the prior art;

FIG. 4B shows a type of layered hairpin;

FIG. 4D shows an example of I-pin, according to the prior art;

FIG. 4E shows an example of “W-pin,” according to the prior art;

FIG. 4F shows an example of an “inversion hairpin,” according to the prior art;

FIG. 4G shows an example of overlapping hairpins on different layers, according to the prior art;

FIG. 4H shows an example of overlapping hairpins on the same layer, according to the prior art;

FIGS. 5A-5D correspond to FIGS. 24A, 29, 31, 34 of Odawara's patent application US2019/0190359, where some elements commented on above have been circled;

FIG. 6 shows a first draft of the layout of the assembly and insertion system for assembling and inserting a winding into a stator, according to an aspect of the invention;

FIG. 7A is an example of assembly of the winding with a single circular containment, a perspective cutaway view in (a), and a section view perpendicular to the winding axis in (b), according to an aspect of the invention;

FIG. 7B an example of winding tightening, a perspective cutaway view in (a) and a section view perpendicular to the winding axis in (b), according to an aspect of the invention;

FIG. 7C shows an example of the transfer of the winding into the pack, according to an aspect of the invention;

FIG. 7D shows a partial opening of the circular containment, according to an aspect of the invention;

FIG. 7E shows an example of thrusting the winding into the pack, according to an aspect of the invention;

FIG. 7F shows a complete opening of the circular containment, according to an aspect of the present invention;

FIG. 8 shows an assembly solution with multiple circular containments according to an aspect of the invention;

FIG. 9A shows an example of a winding assembly with multiple circular containments, a perspective cutaway view in (a), and a section view perpendicular to the winding axis in (b), according to an aspect of the invention;

FIG. 9B shows a re-compacting of the winding, according to an embodiment of the invention;

FIG. 9C shows tangential tightening according to an embodiment of the invention;

FIG. 9D shows a separation of the inner containment;

FIG. 9E shows a transfer of the winding into the pack;

FIG. 9F shows an opening of a lower circular containment;

FIG. 9G shows an opening of a central circular containment;

FIG. 9H shows an opening of an upper circular containment;

FIG. 10 shows the possible movements of a circular containment;

FIG. 11 shows a movement of the cam from outside the diameter of the hole, an action that would lead to a collision with surrounding parts;

FIG. 12 shows a bottom view of the table with the circular containments;

FIG. 13 shows a drive assembly-front view;

FIG. 14 shows a disengaged drive assembly-section view;

FIG. 15 shows an inserted drive assembly-section view;

FIG. 16 shows a principle diagram of a first embodiment of the invention;

FIG. 17 shows a principle diagram of a third embodiment of the invention;

FIG. 18 shows an overall chosen solution for winding assembly and transfer into the stator pack;

FIG. 19 shows a rotary table assembly-section view;

FIG. 20 shows an embodiment of a circular containment;

FIG. 21 shows a detail of the containment wall;

FIG. 22 shows an inner containment support assembly;

FIG. 23 shows an example of a motor unit for movement in a circular containment, with belt transmission;

FIG. 24 shows an example of a motor unit for movement in a circular containment, with gear transmission;

FIG. 25 shows an example of a pneumatic clamping assembly of a circular containment;

FIG. 26 shows a support surface assembly with an electrically adjustable lift;

FIG. 27 shows a winding thrust assembly in the pack; closing step (in (a)) and thrusting step (in (b)); and

FIG. 28 shows a base frame assembly.

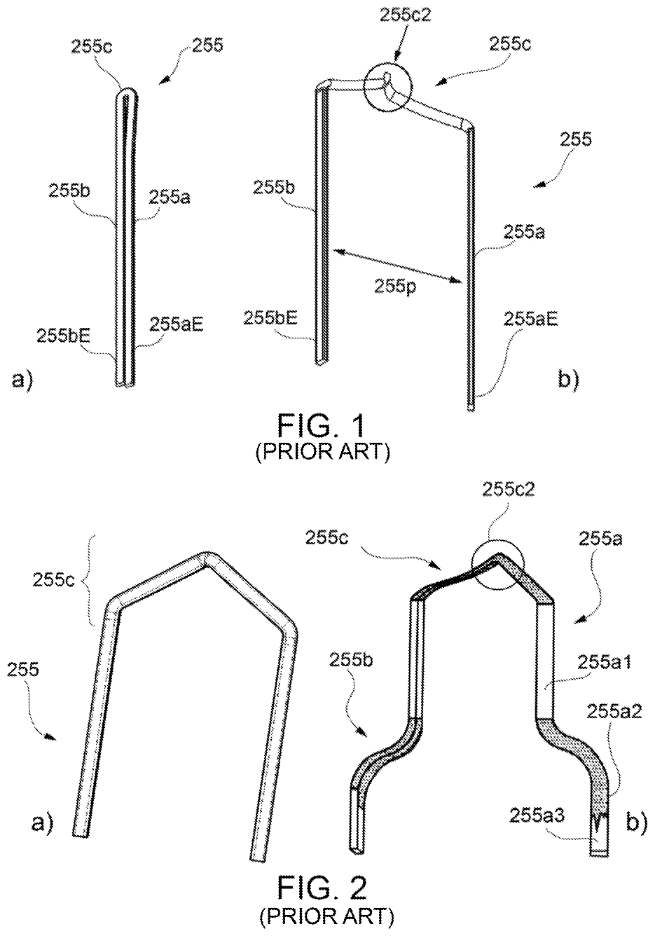

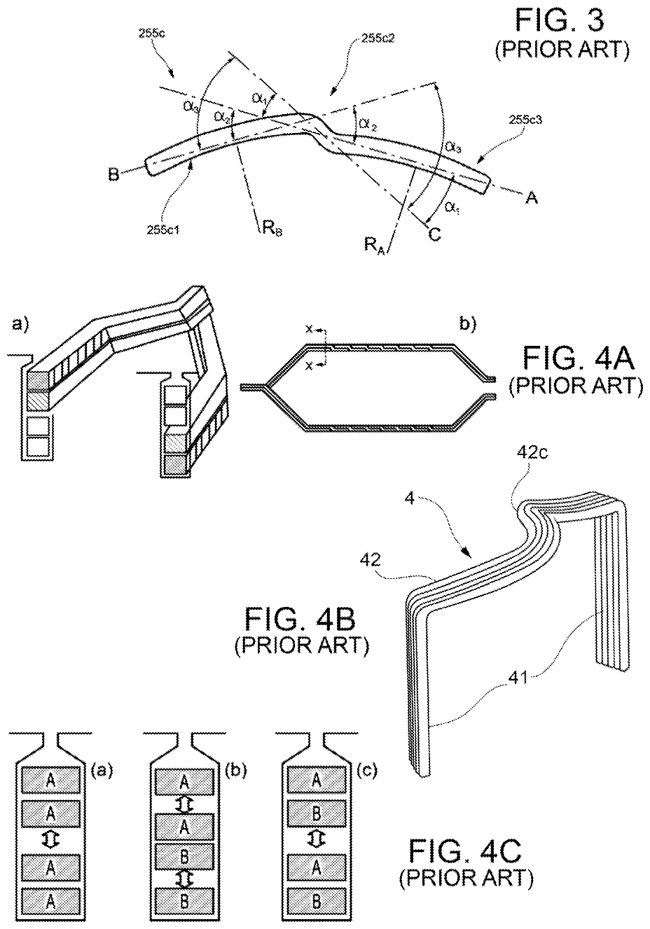

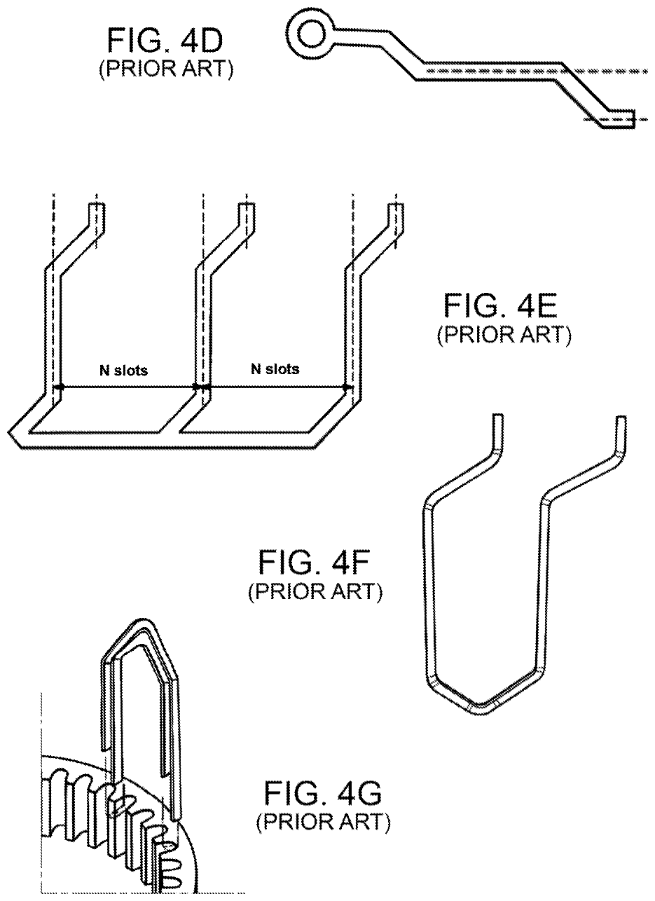

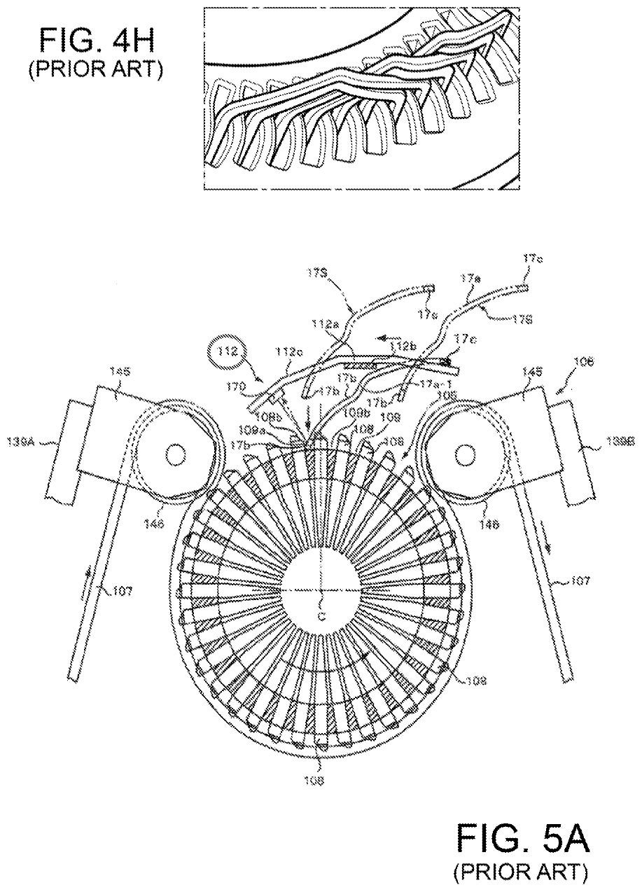

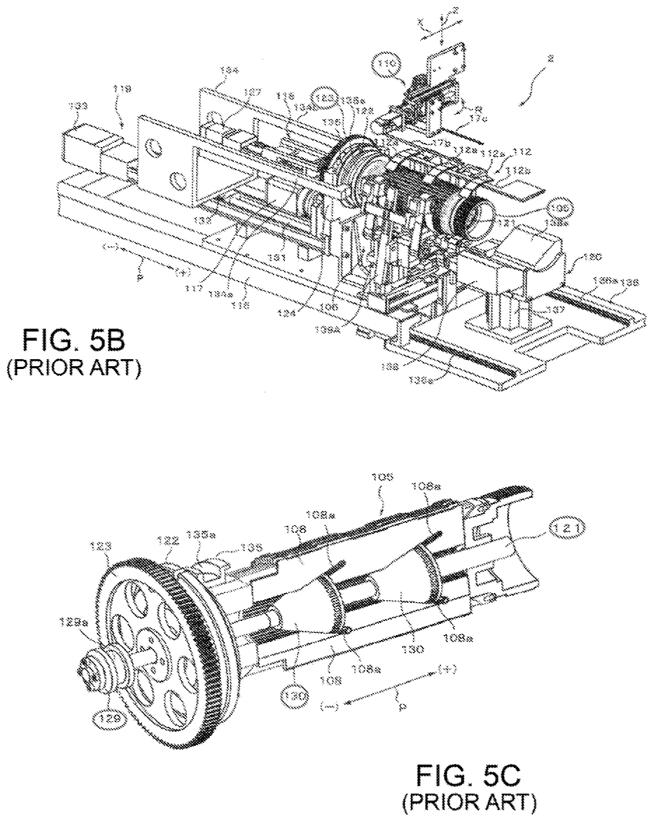

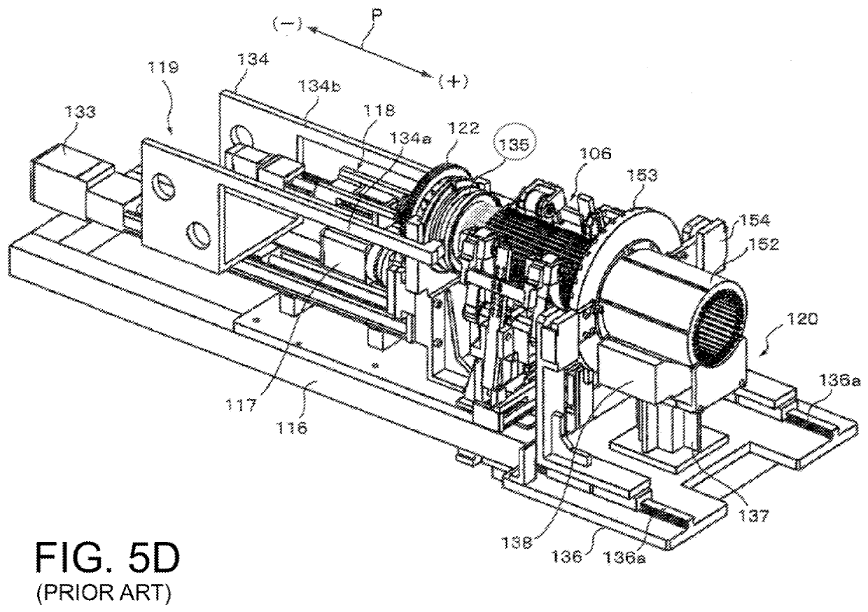

It is worth noting that hereinafter elements of different embodiments can be combined together to provide further embodiments without restrictions respecting the technical concept of the invention, as a person skilled in the art will effortlessly understand from the description.

Furthermore, the present description also refers to the prior art for the implementation thereof, as for detail features not described, such as elements of minor importance usually used in the prior art in solutions of the same type, for example.

When an element is introduced, it is always understood that there can be “at least one” or “one or more”.

When a list of elements or features is given in this description, it is understood that the finding according to the invention “comprises” or alternatively “consists of” such elements.

When listing features within the same sentence or bulleted list, one or more of the individual features can be included in the invention without connection to the other features in the list.

### Embodiments

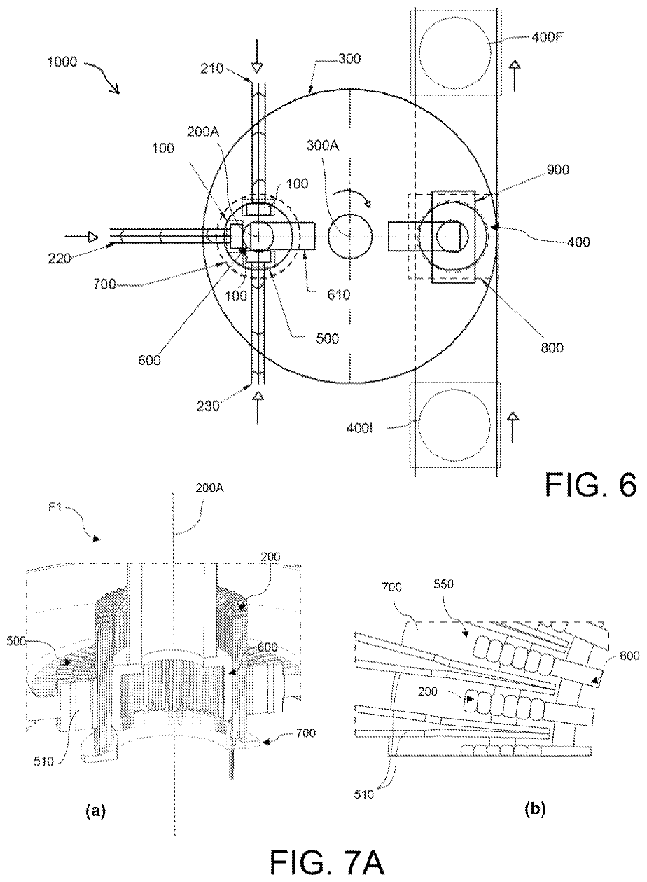

FIG. 6 shows an example of the arrangement 1000 of components for the assembly of a winding 200 (not shown in the figure) and its transfer into a stator pack 400. The input stator 4001 is initially empty. The winding is assembled on a rotary table 300 on the left while the stator is moved along the linear path shown by the arrows on the right. Of course, the positions can also be reversed and not at 180°. Then, the rotary table 300 is rotated (e.g., clockwise as shown by the arrow) about the axis 300A (exiting the sheet) until it encounters the empty stator 4001 in the middle position (or generally other convenient position) along its path, in which the winding is inserted. Thus, a stator pack with inserted winding 400F is obtained at the output. The rotary table 300 allows simultaneously working on two stations, one for assembling the winding and the other for transferring into the stator pack, thus reducing the production cycle time.

The elements composing the system include:
one or more removable inserter(s) 100 (or “removable insertion means”), capable of housing the various basic conductors from respective feeding means 210,220,230, which can start from the assembly area and insert them serially one by one into the circular containment (continued);
a circular containment 500 (or “circumferential containment means”), configured to contain the basic conductors when assembling the winding and then align them appropriately so that the winding has sufficient precision to ensure its insertion directly into the stator pack; the circular containment is conveniently housed in a corresponding hole in the rotary table;
optionally, a basic conductor support surface 700, located under the rotary table 300, the support surface 700 sustaining the basic conductors from below when assembling the winding;
a thrust assembly 800, which presses the stator pack from below to let the winding enter into the stator pack up to a given height; and/or
a movement assembly 900, configured to lower the winding by thrusting it from the side of the basic conductor heads until the basic conductor terminals enter into the slots typically by a few tens of millimeters; and
optionally, a support 610 of an inner containment 600 useful for the winding of the assembly.

The respective feeding means 210,220,230 can supply the basic conductors of the layers 1 and 2 (210), the basic conductors of the layers 3 and 4 (220), and the basic conductors of the layers 5 and 6 (230), respectively.

The choice of a rotary table allows compacting the system, being capable of utilizing, as will be seen, the spaces above and below the table (i.e., on the side of a first table surface, and on the side of a second table surface opposite to said first table surface). Furthermore, it allows improving the cycle time, because during the insertion of a winding into the respective stator pack, progress can be made with the assembly of an additional winding to be inserted into a further stator pack.

Furthermore, it must also be specified that the inserter cannot also insert all the basic conductors of the winding before it is transferred by rotating the table. The missing basic conductors can be inserted into an intermediate station (not shown) and/or into the insertion station in the stator pack before the insertion itself into the stator pack.

Again, the arrow which illustrates the feeding of the stator pack 4001 identifies an arbitrary, albeit preferred, feeding direction. The stator pack can be fed to the winding insertion position from any direction and in any manner, as long as the stator pack is supplied from the side of the table opposite to the side of the inserter 100.

The inserters 100 (not shown in detail) can be of various known or unknown types because they intervene from the outside and do not affect the containment and insertion of the winding. Preferably, the inserter is positioned above the circular containment which will be illustrated, thus on one side of the table only.

### Circular Containment

A first function of the circular containment 500 is to sustain the basic conductors laterally and externally when assembling the winding. This is done by making use of a containment with circumferential geometry having as many walls as the slots in the stator pack so as to recreate a pack-like structure. However, as will be seen, the slots formed by the walls of the circular containment have a variable width due to the radially variable cross-section of the walls. This allows spreading the crowns needed to assemble the winding.

For the radial movement of the walls, as will be illustrated with reference to FIG. 14, cams 910 are provided in the circular containment, which indeed moves the walls in radial directions.

A second function of the circular containment 500 is to hold in place (calibrate) the winding during the rotation of the table (transfer) and a third function of the circular containment is to organize and align the conductors of the transferred winding for the insertion into the stator pack.

Multiple circular containments (collectively “circumferential containment means”) can be used at the same time, as illustrated hereafter.

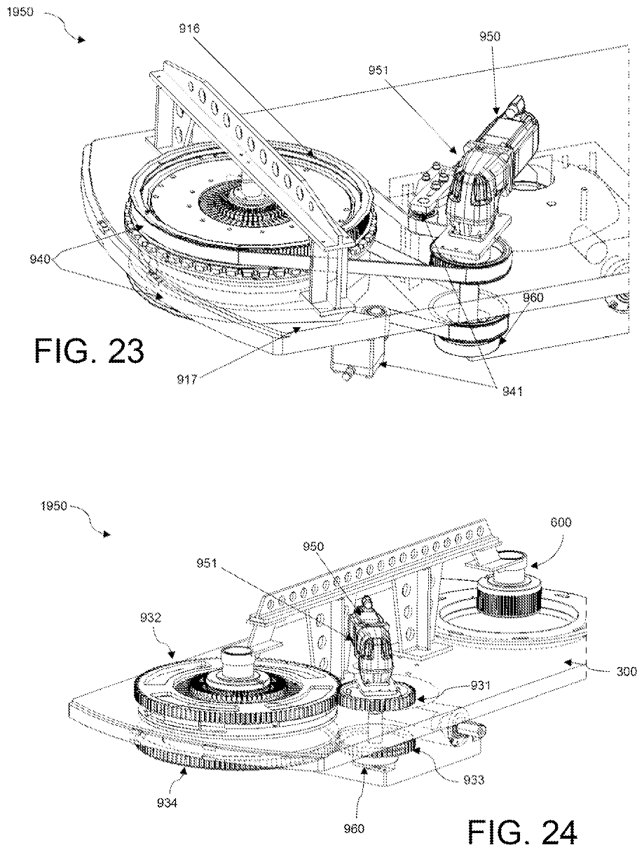

The circular containment 500 can be handled by means of a dedicated circular motion transmission system 917 shown in FIG. 23.

### Use of a Single Circular Containment

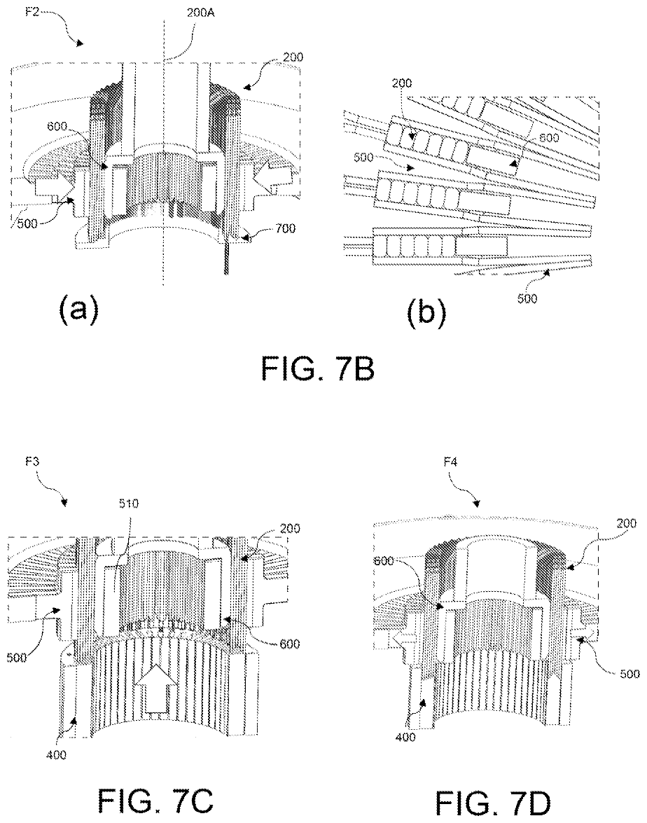

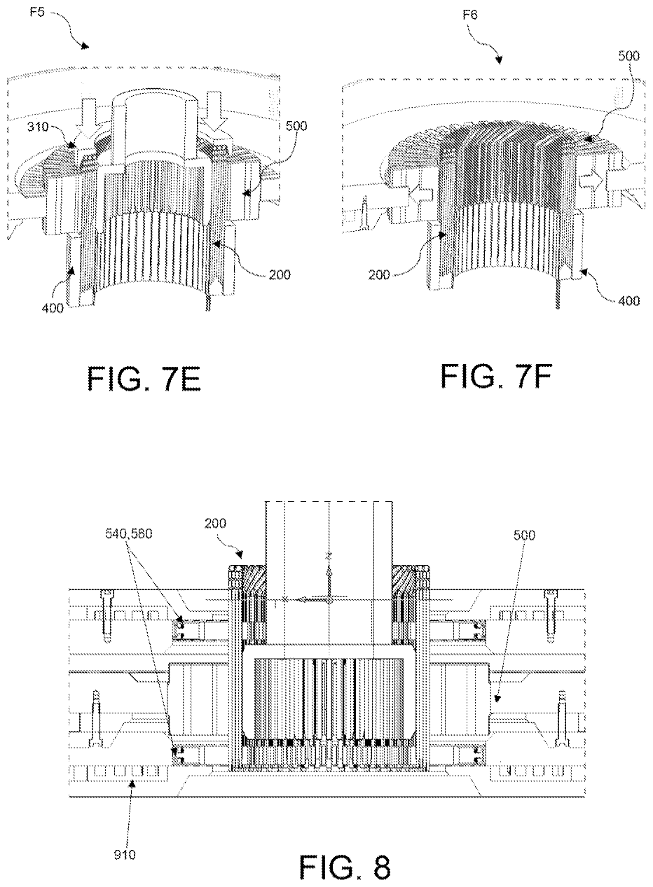

This solution provides that the containment and gripping system (or “circular containment” or “circumferential containment means”) of the winding can comprise (FIG. 7A):
A circular containment 500 with fingers or positioners 510 of predetermined length and radially variable thickness, the function of which is both containment and calibration, as mentioned above;
Optionally, an inner containment 600, the function of which is to act as a reference abutment for the winding inner diameter 200; and
Optionally, a support surface 700, provided with possible notches for the basic conductors longer than the standard basic conductors and possibly equipped with edges to prevent the basic conductors from escaping, the support surface being placed on the side of the table opposite to the side of the inserters 100, but still in the assembly position.

An example of an operation with successive work steps is now illustrated, in which advantageously all the elements just listed are used, although some are optional as indicated.

Step F1 shown in FIG. 7A consists in the assembly of the winding with a single circular containment 500. Initially, the circular containment 500 is in the winding assembly position, the support surface 700 is lifted, and the inner containment 600 prevents the basic conductors from moving inward. In this step, a set of basic conductors is inserted into the slots 550 of the circular containment 500 on the side of the free ends of the basic conductors, and with each insertion, the circular containment 500 will rotate (by one or more slot pitches defined as the angular distance between the slots, by appropriate rotation means about the winding axis 200A) carrying the winding being assembled therewith. The assembled winding will be obtained at the end.

Step F2 shown in FIG. 7B consists in the tightening of the winding: the circular containment 500 thrusts the basic conductors radially against the containment because its section (orthogonal to the axis 200A) is tapered at least partially, the support surface 700 remains lifted, in turn the inner containment 600 remains in place and acts as an abutment for the basic conductors.

The basic conductors can be tightened radially (e.g., by means of a shoulder, described below) and/or tangentially, depending on wall thickness. Indeed, in general, tangential tightening is best suited when the insulating paper (usually used in the technical field) is ‘S’-shaped, double ‘S’-shaped, ‘B’-shaped or, more generally, when the paper crosses the slot internally because a radial distance between conductors belonging to the same slot must be ensured.

Radial tightening, on the other hand, works well when the paper is of the ‘O’ type or, in general, when the insulation is only at the edges of the slot because the circular containment compacts the conductors together and thrusts them against an inner abutment. Tangentially, the walls of the positioners can align the conductors so that they do not protrude beyond the area of the slot (minus that of paper).

Step F3, shown in FIG. 7C, consists in the insertion of the winding into the stator pack by suitable introduction means. The rotary table 300 (shown in FIG. 6) takes the circular containment with the winding over the stator pack 400 with a rotation around the rotary table axis 300A, and the stator pack is lifted (or the winding is lowered) until the basic conductors are inserted (e.g., for about 10-20 mm) into the corresponding slots of the stator pack. In general, the rotary table takes the circular containment means from an assembly position to an insertion position in the stator pack. Conveniently, the stator pack is taken to the insertion position by special feeding means from the side of the rotary table opposite to the side in which the inserters are in the assembly position.

Step F4, shown in FIG. 7D, consists in the partial opening of the circular containment 500 (radially). While the stator pack 400 is stationary, the positioners 510 of the circular containment 500 move back slightly to create some clearance between the walls and the basic conductors.

Step F5, shown in FIG. 7E, consists in the thrusting of the winding into the pack. While the stator pack 400 is stationary, e.g., an upper abutment 310 thrusts the basic conductors into the stator pack itself.

Step F6, shown in FIG. 7F, consists in the wider or fuller opening of the circular containment 500; the stator pack 400 is stationary, the circular containment opens, and the inner containment 600 (not shown in the figure) rises.

Using only one circular containment is possible and has the advantage of having fewer components and smaller footprint.

### Use of Multiple Circular Containments

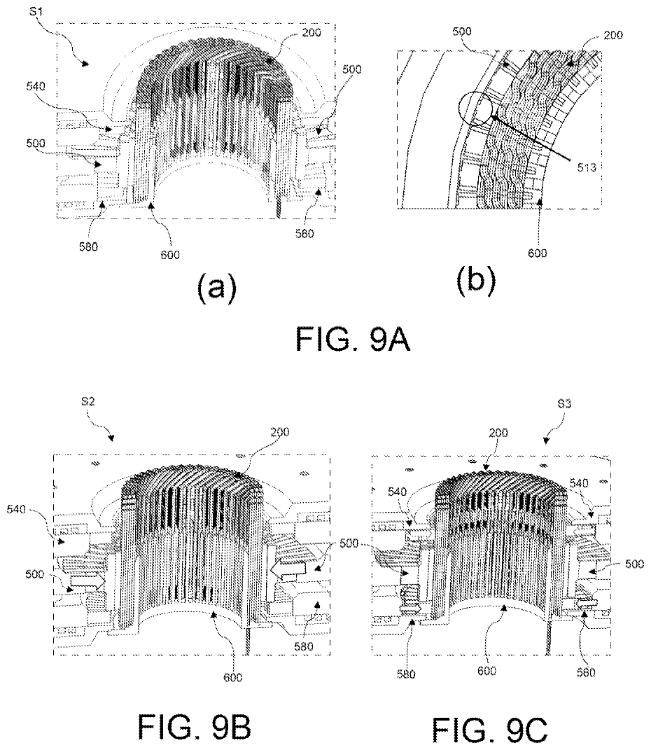

To better control the winding and to reduce the radial travel of the circular containment 500, other circular containments can be used, which preferably take care of the tightening of the winding. With reference to FIG. 8, it is advantageous for the additional circular containments 540,580 to be placed immediately below and immediately above the circular containment already described. An example of the use of multiple circular containments in successive work steps is described below. It is to be understood that even one additional circular containment can be used, as illustrated above, and resumed hereafter.

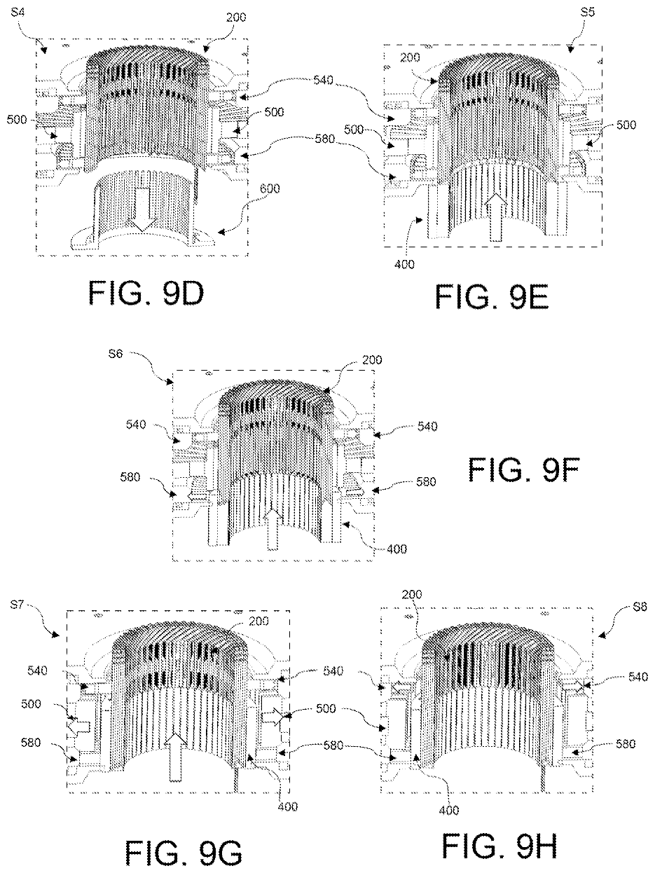

Step S1, shown in FIG. 9A, consists in a tangential tightening: the upper and lower circular containments 540,580 are fully retracted, the middle circular containment 500 is in the assembly position, and the support surface 700 (optional, not shown in this figure) is lifted to sustain the basic conductors.

At this step, all the expected basic conductors are inserted one by one, and with each insertion the central circular containment 500 rotates, taking the winding 200 therewith. Step S1 ends with the assembly of the entire winding 200. The tangential shoulders 513 for radial compacting can be present in one or both of the lower and upper 540,580 circular containments (FIG. 9A(b)).

Step S2, shown in FIG. 9B, consists in a compacting of winding 200. At this step, the circular containments 540,580 are fully retracted while the central circular containment 500 advances and compacts the basic conductors radially against the containment 600; the support surface 700 is lifted.

Step S3, shown in FIG. 9C, comprises the advancing of the lower and upper circular containments 540,580 until the basic conductors are tightened tangentially, the circular containment 500 thrusts and compacts the winding against the containment 600 as in step S2, and the support surface 700 remains lifted in the containment position (always not shown).

As for the radial movement of the positioner 510, in order to compensate for manufacturing tolerances of both the positioner and the basic conductor and thus ensure optimal positioning of the basic conductors in the containment, elastic means (e.g., springs) positioned behind each positioner 510 can be used (elastic means are not shown in the figures).

Step S4, shown in FIG. 9D, comprises the separation of the inner containment 600 while the winding is still in the assembly position on the left in FIG. 6. At this step, the tangential circular containments 540,580 are tangentially thrusting the basic conductors while the circular containment 500 is as in step S2, finally the support surface 700 (not shown in the figure) lowers.

Step S5, shown in FIG. 9E, concerns the insertion of the winding 200 into the stator pack 400, then after the rotary table has taken the winding from the assembly position to the insertion position (e.g., 180°, but other positions are also possible according to the concept of the invention, e.g., four 90° positions).

At this step, the winding is positioned over the stator pack, the upper and lower circular containments 540 and 580 are gripping, the middle circular containment 500 is located as in step S2, and the stator rises and houses the basic conductors (by means of their free ends).

Step S6, shown in FIG. 9F, comprises the opening of the lower circular containment 580. At this step, the upper circular containment 540 is gripping, the middle circular containment 500 is as in step S2, while the lower circular containment 580 retracts and the stator 400 is lifted and continues the insertion.

Step S7, shown in FIG. 9G, comprises the opening of the central circular containment. At this step, the upper circular containment 540 is gripping, the lower circular containment 580 is retracted, while the central circular containment 500 retracts and the stator 400 rises and continues the insertion.

Step S8, shown in FIG. 9H, consists in the opening of the upper circular containment 540. At this step, lower circular containment 580 and the circular containment 500 are retracted, while the upper circular containment 540 retracts and the stator 400 rises and continues the insertion. In this manner, the winding is inserted into the stator pack, which becomes the complete stator pack 400F (i.e., the stator before twisting and welding the inserted winding) of FIG. 6, from where the stator pack is driven by appropriate removal means, which can form a single assembly with the feeding and/or positioning means.

Consequently, according to the invention, one or more circular containments can be used according to the height of the stator pack; for packs with limited height, only one circular containment can be used; for packs with high height, it is preferable to use several circular containments for uniform containment along the height of the winding.

### Comparison of Some Possible Solutions for the Assembly and Insertion System

For the study of the entire assembly and insertion system, the starting point has been the movement of circular containment and in particular the analysis of the necessary automation. Indeed, it has been found that, by using a rotary table to move the winding from the assembly work station to that of insertion in the stator pack, different configurations are possible by arranging the components either outside the rotary table or integral therewith.

As for the assembly of the winding itself, it is possible to act in two ways, for example: in the first case, it is possible to hold the circular containment fixed and rotate the inserter about the axis of the winding while inserting the basic conductors; in the second case, it is possible to hold the inserter fixed and rotate the circular containment below it.

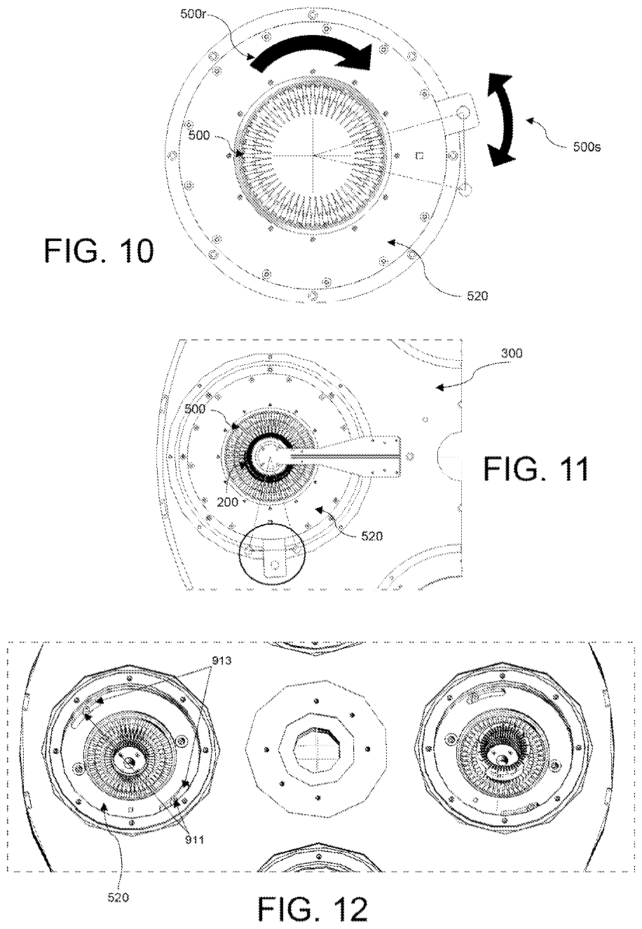

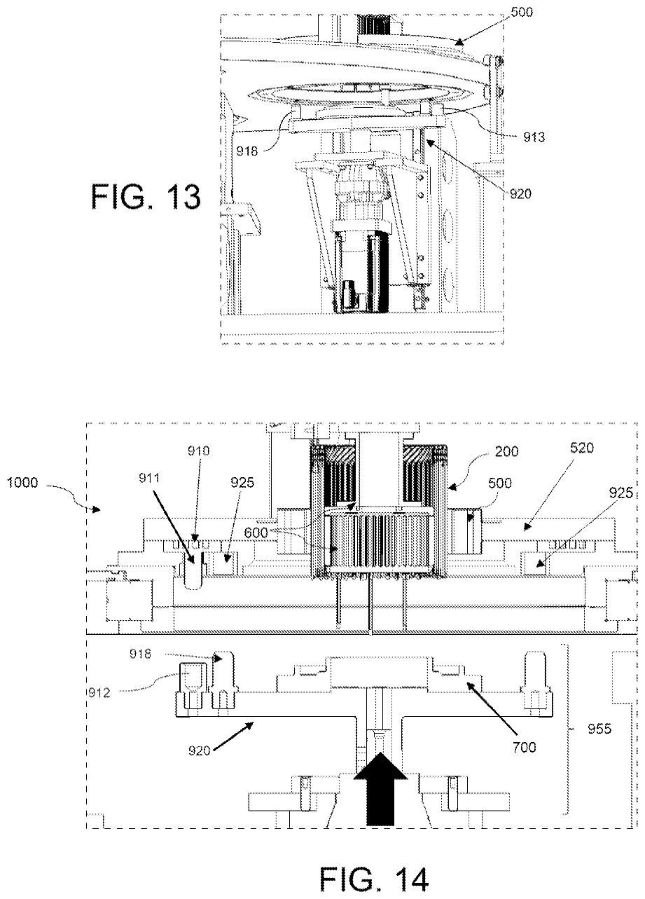

Since the inserter normally has a structure which does not allow it to be easily rotated about the entire circumference of the winding when inserting basic conductors, it is preferable to hold the inserter fixed and rotate the circular winding containment in assembly. In many cases, only one circular containment can be used for both assembly and winding calibration and tightening. According to the present invention, two movements can be made with circular containment (as shown in FIGS. 10 and 11): the rotary motion 500r of the entire circular containment and the motion 500s on an arc of circumference to move the cams (as described in greater details below) in the body of the circular containment 520, which radially advances the positioners of the circular containment. Different means for the radial movement of positioners can be provided.

The positioning of the circular containment 500 above the rotary table 300 and especially the choice of rotating the circular containment when assembling the winding involves the use of circular containment rotating means, which can be realized in many different ways.

For example, one possible choice is to provide holes 912 (engagement holes, see FIGS. 12 and 14) on the base of the circular containment to allow the pins 918 (shown in FIG. 14) of the drive system to be capable of engaging the circular containment itself. The cam 910 will also move from underneath the circular containment with pins 911 connected to a fork coaxial with the drive assembly 955 of the entire circular containment. See also FIG. 14, engagement pin 911, for the position of the cams 910. The cam can be moved by the system 916 shown in FIG. 23.

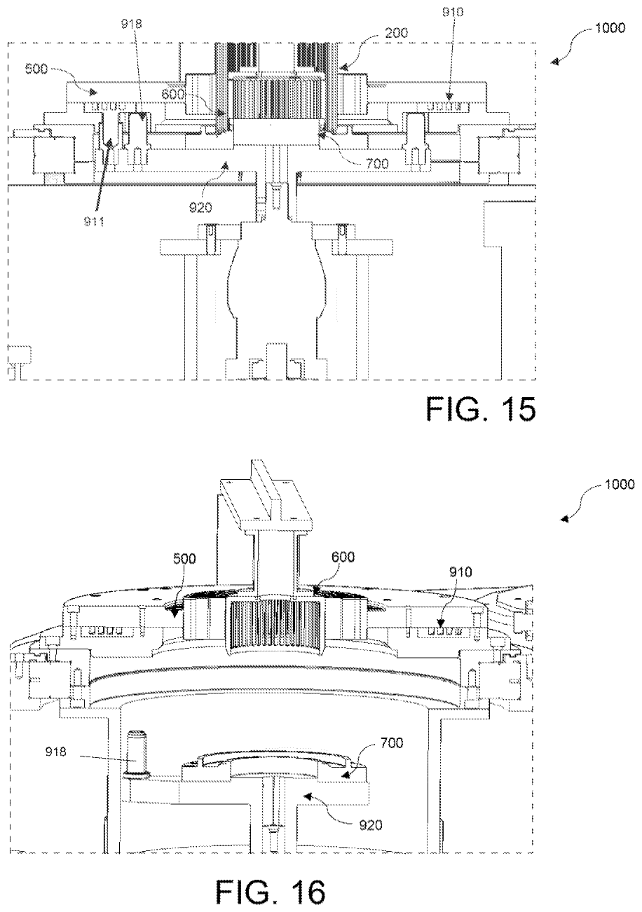

The base plate 520 of the circular containment in FIG. 14 has two (/one or more) recesses 925 into which two (/respective) pins 918 are inserted (FIGS. 14-16) at 180°, which are used to transmit the rotation of the entire circular containment from the rotation means 950 (FIG. 23); furthermore, there are two (/one or more) slits 913 from which two (/respective) pins 911 connected to the cam protrudes. With a relative movement between the cam pins 911 and the base plate 520, for example, it is possible to manage the rotation of the cam and thus the radial movement of the positioners. Reference numeral 920 indicates the drive assembly which rotates the base plate 520.

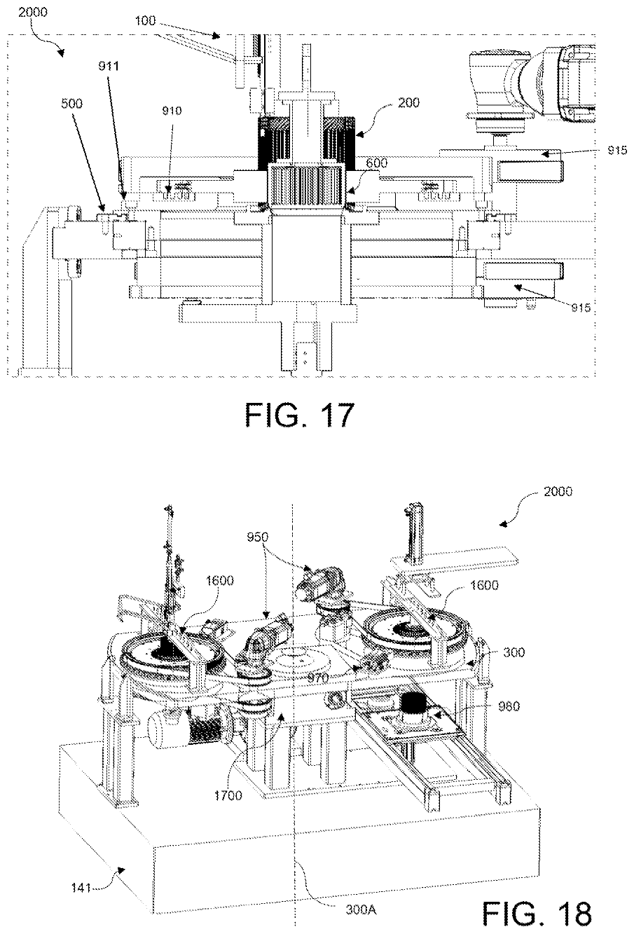

From the study of process steps, it has been seen that at the winding assembly work station on the rotary table, it is necessary to perform both movements 500r and 500s (FIG. 10), in which the movement 500r is used for rotating the entire containment system for the insertion of the basic conductors, and the movement 500s need not necessarily be of 360°, it is used for radially moving the individual positioners both at the first assembly work station and preliminarily at the work station for the insertion into the stator pack. In the inserting work station of the winding into the stator pack, only the cam movement can suffice (although for the insertion of some special basic conductors, it is preferable to provide both movements). This has led to the conclusion that it is preferable (as in FIGS. 17, 18, and 24) to place the cam movement assembly aboard the motor 950 (with reduction gear 951 and belt tensioners 941) of the rotary table to avoid repeated insertions and removals for transfer, and it is also possible to take advantage of the above assembly to hold the cam stationary during the table rotation.

### Single Motor Integral With the Rotary Table

Referring to the embodiment 2000 in FIG. 17, in order to reduce the number of motors used, since the movement of the cam is short compared to the movement of the circular containment body, an insertion and removal system of the pulley 915 connected to the circular containment body can be inserted, thus transmitting motion only to the cam while holding the circular containment body stationary.

This embodiment 2000 can be realized by using an electrically controlled brake connected to the pulley of the circular containment body, or by taking advantage of an electromagnetic clutch (not shown).

The operation of the solution 2000 (combinable with the solution 1000) with a single motor integral with the rotary table can be diagrammatically illustrated in several successive steps:
Lifting and coupling the support surface 700 to the movement system of the circular containment body 520 (pneumatic locking retracts);
Starting the assembly of the winding 200 with rotation of the circular containment body 520 and the cam 910;
Activating the pneumatic locking at the end of assembly and deactivation of the electromagnetic brake;
Lowering the support surface 700 slightly to facilitate the insertion of conductors into the stator pack 400, to which an electric-type drive is required;
Rotating the cam 910 for tightening the winding 200;
Lowering the support surface 700 totally;
Rotating the rotary table 300;
Lifting the stator pack 400 to feed the conductors;
Rotating the cam 910 to a vertical guiding position;
Thrusting the stator pack 400 from below (or vice versa thrusting the basic conductors from above) to insert the winding 200 into the stator pack;
Rotating the cam 910 for full opening;
Lowering the stator pack 400 with the winding 200 inserted;
Repositioning the cam 910 during assembly; and
Rotating the rotary table 300.

The advantages presented by the solution 2000 are the possibility of rotating the circular containment in the winding insertion station; this makes it easier to reach different positions on which to work with special hairpins and to position the winding at any angular position with respect to the stator pack; the use of a single electric motor for the circular containment body and the cam, eliminating weights on the rotary table; as well as the reduction of the overall dimensions under the rotary table.

### DETAILED DESCRIPTION OF A PREFERRED EMBODIMENT

Solution 2000 is a preferred embodiment according to the invention because it is efficient in achieving the purposes of the invention.

Optionally, one motor is used to rotate both the circular containment body 520 and the cam 910. As mentioned above, an electromagnetic clutch will be capable of inserting or removing one of the two motion-transmitting pulleys 915.

A diagrammatic version of the solution is configured as in the overall view in FIG. 18.

Embodiments of each of the assemblies which form the global system (excluding the inserter, which as mentioned above can be of any type) will be illustrated in detail in the following.

### Rotary Table Assembly

As seen, a rotary table 300 has been chosen to work, e.g., on two stations, one for assembling winding under the inserter 100 and the other for inserting the winding into the stator pack 400, at the same time with very short rotation times of the table. It is preferable to rotate the table by 180° in one direction and then in the opposite direction so as to avoid complicated electric and pneumatic connection systems. In all embodiments of the present invention, the two (or more) stations can be housed in corresponding holes 310, 320 of the rotary table.

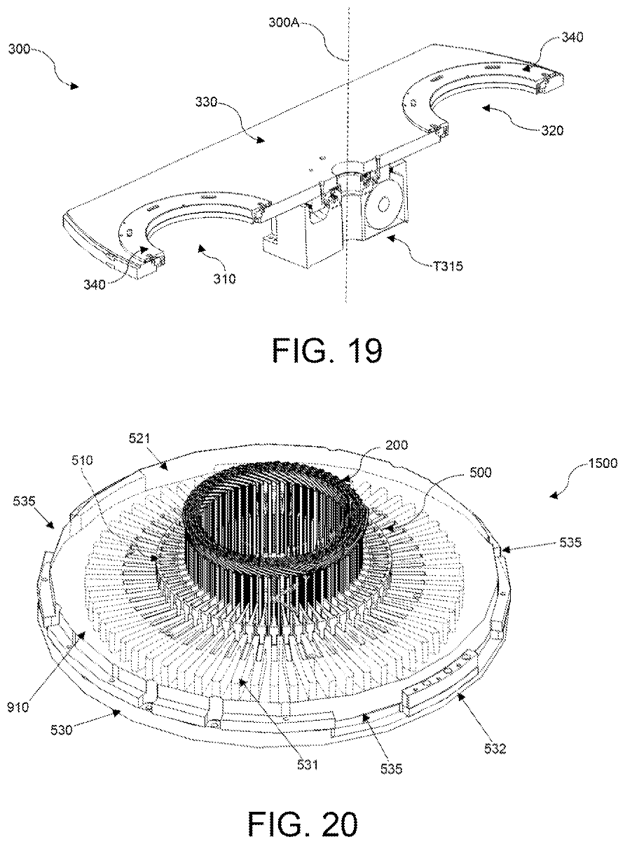

One rotating element which can be considered is, for example, the element TR315 made by Bettinelli shown in FIG. 19, on which a work surface 330 was mounted made (for example) with two linear cuts from a circumference with a diameter of about 1900 mm and with two holes 310 and 320 to house the circular containment at the two work stations. A cross roller bearing 340 can be housed on each hole, such as the THK RB45025 bearing to the top of which a plate is connected on which the circular containment is connected.

The table 330 can also be configured to house the storage (not shown) of any special basic conductors to be inserted into the transfer station.

### Circular Containment Assembly

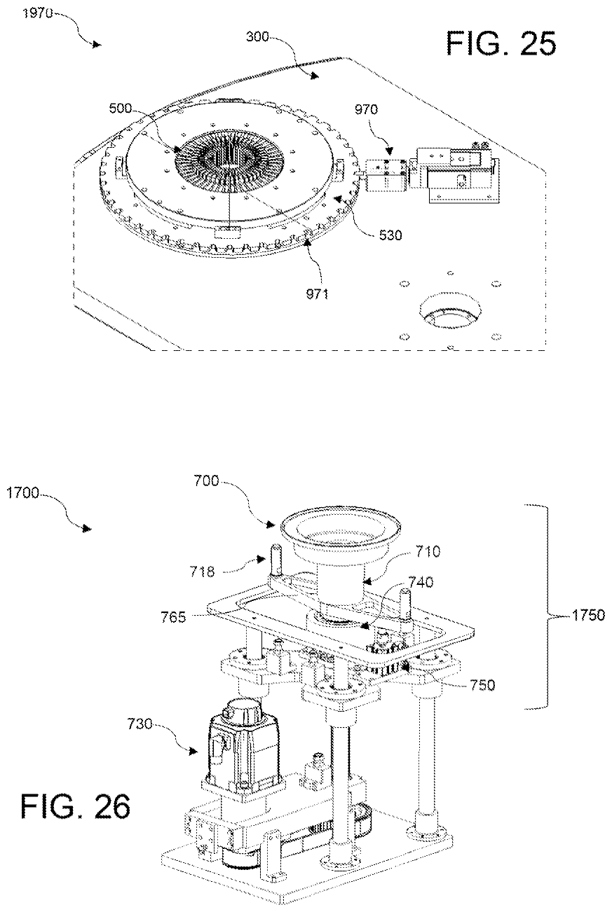

The circular containment assembly 1500, shown in FIG. 20, can comprise one or more of the following elements:
a base plate 530, externally provided with notches (toothing, shown in FIG. 25) for the pneumatic locking of the circular containment in one of 48 desired positions (even number, multiple, or dividend of the number of slots of the stator pack being processed);
a cam 910, which, by rotating, moves the walls of the circular containment;
a cover 521, appropriately designed for the function of guiding the positioners 510;
as many positioners 510 as the slots in the stator pack to recreate a pack-like structure;
sliders 531, which transmit motion to the positioners and are preferably equipped with springs (not shown); and
a connection for the transmission 532 with which a specific element is engaged, which allows the movement thereof (toothed wheel or belt pulley or other) configured to rotate the cam.

The circular containment 500 is connected by means of the base plate 530 on the rotary table 300 (not shown in the figure) and is free to rotate.

As the thickness of the positioners 510 (the part in contact with the conductors) increases radially, rotating the cam it is possible to form stator-like slots, more or less narrow than them. Hence, the concept is to recreate wider slots during assembly and then narrower slots to align the basic conductors, with obvious advantages in the simplicity and effectiveness of assembly and winding insertion into the stator pack.

The positioners can be conveniently guided by special guides provided in a plate cover element 521 (not shown). These guides can allow a given stroke to be maintained in all steps of operation.

The cam 910 is provided with external protrusions 532 onto which the pulley or wheel, which puts it in rotation, is supported and fixed.

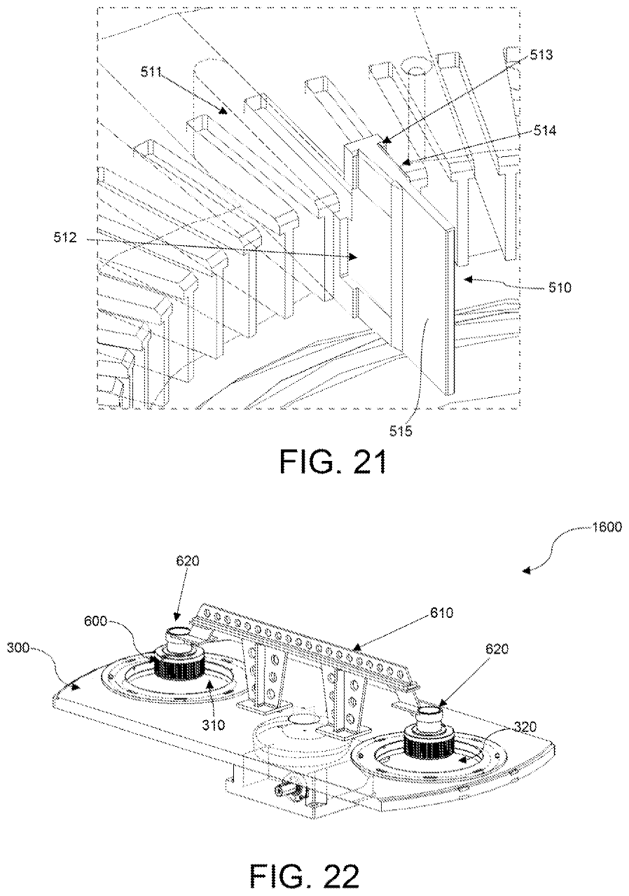

Looking in detail at the positioner 510 in FIG. 21 (and in any embodiment), it can be guided into a respective block 511 through springs (see above, for a better tangential grip).

The positioner 510 can also be shaped to have in section a first portion of the radially inner end with a fixed thickness 515 and then a second tapered (wedge-shaped) portion 514 toward the radially outer end.

Advantageously, the second portion has a first sub-portion with a first sub-length having a first tapering angle and a second sub-portion, contiguous to said first sub-portion, with a second sub-length having a second tapering angle.

Preferably, wherein each positioner 510 has, in at least said second sub-portion, along the direction 200A of the winding axis, a first end and a second vertical end, wherein at said first vertical end there is a first vertical portion with said tapering and at said second vertical end there is a second vertical portion with said tapering, and wherein there is a central portion 512 without tapering between said first and second vertical portions with said tapering.

In addition, a T-shaped shoulder 513 can be included, for example, at its outer radial end to bundle the conductors radially.

### Inner Containment Support Assembly

The optional inner containment support assembly 1600 shown in FIG. 22, can comprise two main subassemblies: a fixed support 610 integral with the rotary table 300 and a support structure 620, which can be equipped according to the size of the winding to be processed.

The tooling structure 620 comprises an inner containment 600 with circular geometry which is used to give the reference of the inner diameter of the winding. It thus facilitates the insertion into the stator pack and has as many slots as the walls of the positioners so as to be crossed by the latter.

For example, the inner containment 600 (adapted not to keep the basic conductors of the winding from falling radially inward) is supported by means of a support (or basket) 620 rigidly connected to the fixed support 610, which connects the two assembly and insertion positions on the rotary table in the 180° configuration.

### Circular Containment Motor Unit

The motor unit of the circular containment 1950, shown in FIG. 23, is the assembly that allows both the entire circular containment 500 and the cam 910 only to rotate; this is made possible by virtue of the electromagnetic clutch 960, which engages and disengages the rotations of the two pulleys 940 or toothed wheel 931-934 (see FIG. 24) for the transmissions.

It is possible to provide the device according to the invention with transmission means (e.g., above the rotary table), which are used to put the inner cam and the circular containment into rotation and are constantly connected to the motor. These transmission means can, for example, be made with a single motor to whose shaft the rotational part of the circular containment is connected, whereas the rotational part of the cam is implemented, when necessary, by means of independent connection to the shaft with mechanisms, such as an electrically controlled clutch.

### Circular Containment Locking Assembly

The optional pneumatic locking assembly 1970, shown in FIG. 25, is used to lock the circular containment 500 when the electromagnetic clutch decouples the transmission with respect to the body 520 of the circular containment, which would then be in danger of moving.

The pneumatic lock 970 is designed in a normally closed configuration and thus must be operated to release the circular containment, for safety issues.

The lock can be placed on top of the table 300 and can act directly on the base plate 530 of the circular containment, on the outer circumference of which positioning notches 971 are made in number equal to or a multiple of the number of stator slots, this allows locking the circular containment at least at each slot pitch.

Advantageously, when assembling the system, the locking assembly can be aligned with the notches on the circular containment since an error in doing so would result in displacement of the body of the circular containment when the clutch is deactivated and the pneumatic lock is activated, and consequently, there would be a step error between the upper and lower transmissions. At this point, it is advantageous to provide at least one angular adjustment of the pneumatic locking unit.

If the accuracy of a pneumatic locking device 970 is too low for a specific application, or the precautions to be applied are too sophisticated, an electromagnetic-type brake can also be used along with a clutch. In this manner, the brake would always be activated before the clutch (with the circular containment stationary) with the advantage that, once the clutch is deactivated, the brake would have no settling problems but would remain exactly still. The clutch is reactivated and the brake is deactivated to re-engage the transmission of the circular containment body.

Such a solution would not only allow for more precise control with quick and easy commands but also releasing the clamping system from the angular position of the circular containment body, saving costs as compared to additional machining operations on the base plate.

### Support Surface Assembly

The support and movement surface assembly 1700, shown in FIG. 26, is placed on the ground under the rotary table and plays the role of supporting the basic conductors from below when assembling the winding.

It has been seen that it is preferable to have a system capable of handling different lifting heights both in the case of winding format change and during the winding steps of the winding, therefore an electric movement (or electric lifting system) 730 connected by means of a belt drive to a worm screw that moves a plate in a vertical direction (not shown) is preferred.

In the movable subassembly 1750, by means of a bearing, a support 765 being free to rotate with respect to the lifting system, is connected and equipped with pins 720 that allow it to couple to the circular containment where related bushings are housed (they are like 911 in FIG. 12 and are used to drive in rotational motion the entire idle support assembly). There can also be an idle support system 740 of the lifting system, as well as a pneumatic locking system 750 in place.

Indeed, when assembling the winding, the support surface 700 will be connected to the circular containment by means of the aforesaid support and will rotate with the containment itself. Once the assembly is finished, the walls of the circular containment advance and tighten the winding against the inner containment then the support surface 700 lowers and its support decouples from the circular containment. A pneumatic cylinder 710 locks the support surface support in the reference position to which it must be returned before lowering.

It is also possible to manage the height at which the winding must be tightened, which will be the most convenient for transfer into the stator pack, by moving the support surface 700 before the circular containment advances to the tightening position. Therefore, the length of the pins 718 (see above) must be such that the basic conductors can be supported at different elevations without losing connection with the circular containment transmission.

The support surface 700 will be capable of advantageously tracing the projection of the insertion-side basic conductors for effective support. It is actually possible to simplify the support surface if the difference between the basic conductors is a few millimeters because having a support surface with precise notches for each basic conductor and then not being sure of the placement of those conductors would not make sense. Furthermore, having on the insertion side of the basic conductors a nape that is not perfectly horizontal poses no problems for winding assembly.

Instead, it is advantageous to make notches where considerably longer terminals such as step terminals or jumpers are placed and create chamfers so as to facilitate their insertion.

For example, the stroke of the lifting system thus made can be about 200 mm, which is sufficient to manage windings with heights on the order of 300-350 mm (in the PDT step).

### Winding Thrusting Assembly

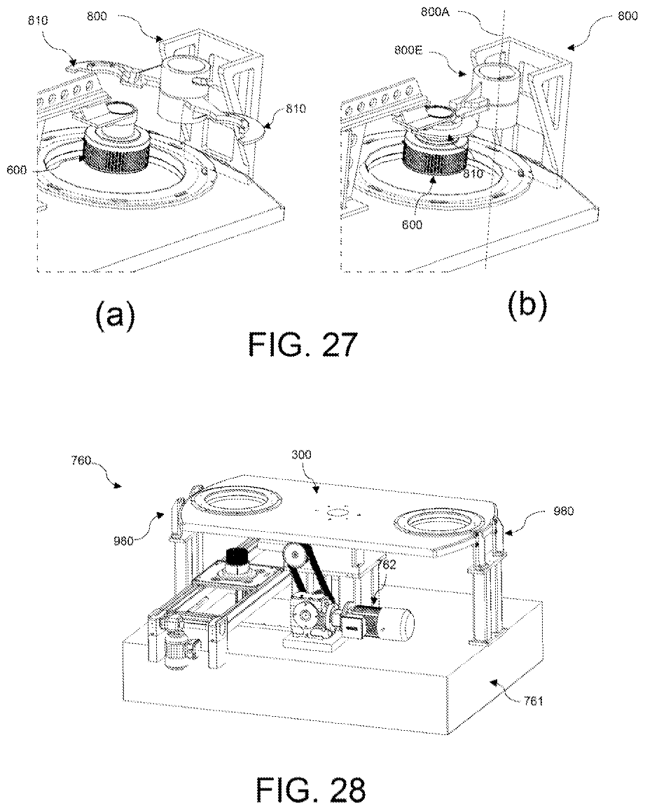

The winding thrust assembly 800, shown in FIG. 27, is intended to thrust the basic conductors into the stator pack when the conductor terminals have already been inserted into the stator pack.

It is designed to thrust the basic conductors from the top down through a single plane which thrusts all the conductors at the same time, and thus also plays the role of bringing the nape onto a single horizontal plane.

The suggested solution comprises an electric axis (not fully shown) that moves a plate (not shown) on which the entire thrust assembly 800 is connected.

The thrust assembly 800 can comprise means for opening and closing half-rings 810 to avoid interference with other elements. The thrust means 800, 810 comprise means 800E configured to move two half-discs 810 on a plane perpendicular to the winding axis from an open position to a closed position in which they form a single thrust disc of said head ends.

### Base Frame Assembly

The base frame assembly 760, shown in FIG. 28, must take the rotary table 300 and all elements interacting therewith to a reference height.

The base frame assembly (one of the possible embodiments) is constructed from an electrically welded structure 761.

The centering rollers and the stator pack lifter (not shown) of the table 980 can be fixed to this base frame, while the rotation motor of the table 762 can be placed under the rotary table 300.

Two or more of the parts (elements, devices, systems) described above can be freely associated and considered as part kits according to the invention.

### LIST OF REFERENCE SIGNS

100—inserter
200—basic conductor winding
200A—winding axis
210—means for feeding the basic conductor layers 1 and 2 to the inserter
220—means for feeding the basic conductor layers 3 and 4 to the inserter
230—means for feeding the basic conductor layers 5 and 6 to the inserter
300—rotary table
300A—rotary table rotation axis
310—first work station hole
320—second work station hole
330—rotary table worktop
340—cross roller bearing
400—stator pack
400I—input stator
400F—output stator
1500—circular containment assembly
500—(central) circular containment
500r—rotary movement of circular containment
500s—limited angular movement of the circular containment body
510—circular containment blade or positioner
511—positioner housing block
512—constant thickness portion of the positioner
513—T-shaped shoulder at the radially outer end of the positioner
514—thickening or flaring of the positioner walls
515—wall portion at the inner radial end of the positioner having constant thickness
520—circular containment body
521—circular containment cover
530—circular containment base plate
531—positioner slider for cam movement
532—connection with transmissions
550—slots
540—upper circular containment
580—lower circular containment
1600—inner containment assembly
600—inner containment
610—inner containment support
620—inner containment support structure (or basket)
1700—support surface assembly
700—support surface
710—pneumatic cylinder
720—lifting system pins of the support surface
730—electric lifting system
740—idle support system
750—pneumatic position locking system
760—base frame assembly
761—electrically welded base structure
762—table rotation motor
765—free support
800—winding thrust assembly
800E—electric axis
810—winding thrust half-discs
800A—rotation axis of the electric axis
900—movement assembly
910—cam
911—cam pins
912—engagement holes
913—slits
915—pulley
916—cam transmission system
917—circular containment body transmission system
918—base plate pins
920—drive
925—holes for pins 918
955—circular containment drive assembly
1950—circular containment motor assembly
940—belt
941—belt tensioners
950—circular containment motor
951—reduction gear
960—electromagnetic clutch
931—primary gear (cam pinion)
932—secondary gear (cam crown)
933—additional primary gear (circular containment body pinion)
934—further secondary gear (circular containment body crown)
1970—pneumatic locking assembly of the circular containment
970—pneumatic locking
971—locking positioning notches
980—stator pack centering rollers
1000—first embodiment for the movement of the circular containment
2000—further embodiment for the movement of the circular containment

Preferred embodiments have been described above and some variants of the present invention have been suggested, but it is understood that those skilled in the art may make modifications and changes without departing from the related scope of protection, as defined by the appended claims.

1. An assembly and insertion system for assembling and inserting into a stator pack a stater winding comprising one or more layers, each layer consisting of a circumferential arrangement of basic conductors the basic conductors comprising a head end and one or more legs with a respective free insertion end, the assembly and insertion system comprising:
circumferential containment means of the basic conductors for assembling the winding, the circumferential containment means defining a set of spaces or slots configured to receive the legs of the basic conductors, an angular distance between two slots being referred to as a slot pitch;
removable insertion means for inserting the basic conductors into said circumferential containment means; and
rotating means for rotating the circumferential containment means about a winding axis, said rotating means being configured to perform rotations of one or more slot pitches about the winding axis;
the assembly and insertion system further comprising a rotary table with a first housing hole of the circumferential containment means, wherein
the rotary table has a first table surface and a second table surface opposite to said first table surface;
the circumferential containment means are configured to receive said basic conductors starting from said free ends, on a side of said first table surface in an assembly position;
wherein
the rotary table is configured to rotate about a table axis so as to bring the circumferential containment means from the assembly position to an insertion position for insertion of the winding into the stator pack;
the assembly and insertion system further comprises feeding means of the stator pack from a side of said second table surface at the insertion position, said stator pack comprising a set of stator pack slots;
the assembly and insertion system further comprises relative introduction means for relative introduction of said winding into said stator pack in said insertion position; and
wherein the circumferential containment means comprise a set of positioners arranged circumferentially and configured to slide radially, wherein a space or slot of said set of spaces or slots is defined between each successive pair of positioners.

2. The assembly and insertion system of claim 1, further comprising a second housing hole in which second circumferential containment means are housed, the second housing hole being arranged at 180° from said first housing hole about said table axis.

3. The assembly and insertion system of claim 1, further comprising means for positioning and removing the stator pack after the insertion of the winding.

4. The assembly and insertion system of claim 1, wherein a section perpendicular to the winding axis of each positioner comprises a radially outwardly tapered portion.

5. The assembly and insertion system of claim 4, wherein each positioner comprises a first radially inner end and a second radially outer end, and wherein a first portion of said section with a first length starting from said first radially inner end is without tapering, and a second portion with a second length starting from said first portion to said second radially outer end is the outwardly tapered portion.

6. The assembly and insertion system of claim 5,
wherein said second portion has a first sub-portion with a first sub-length having a first tapering angle and a second sub-portion, contiguous to said first sub-portion, with a second sub-length having a second tapering angle.

7. The assembly and insertion system of claim 5, wherein a “T”-shaped shoulder is provided at said second radially outer end.

8. The assembly and insertion system of claim 6, wherein each positioner comprises, in at least said second sub-portion, along a direction of the winding axis, a first vertical end and a second vertical end, wherein at said first vertical end there is a first vertical portion with said tapering and at said second vertical end there is a second vertical portion with said tapering, and wherein there is a central portion without tapering between said first and second vertical portions with said tapering.

9. The assembly and insertion system of claim 1, wherein each positioner is moved by cam means which radially thrust the positioner upon a rotation of the circumferential containment means.

10. The assembly and insertion system of claim 1, wherein the circumferential containment means comprise first circumferential containment means configured to act at a first end portion of said winding along the winding axis, second circumferential containment means configured to act at a second end portion of said winding along the winding axis, opposite to said first end portion, and third circumferential containment means configured to act between said first and said second end portions of said winding along the winding axis.

11. The assembly and insertion system of claim 1, wherein an inner containment of the winding is provided in the assembly position and in the insertion position in the stator pack.

12. The assembly and insertion system of claim 1, wherein said relative introduction means comprise thrust means of the stator pack toward the free ends of the basic conductors in said winding until the legs of the basic conductors are introduced into the stator pack slots.

13. The assembly and insertion system of claim 1, wherein said relative introduction means comprise thrust means of the winding, configured to thrust the head ends of the basic conductors until the free ends of the basic conductors are introduced into the slots of the stator pack.

14. The assembly and insertion system of claim 13, wherein the thrust means comprise means configured to move two half-discs on a plane perpendicular to the winding axis from an open position to a closed position in which the two half-discs form a single thrust disc of said head ends.

15. The assembly and insertion system of claim 1, wherein the feeding means of the stator pack are arranged in a straight line so as to then bring the stator pack from a first feeding position to a second insertion position and finally to a third output position.

16. The assembly and insertion system of claim 1, wherein a support surface of the free ends of the basic conductors in the assembly position is provided on the side of the second table surface, the support surface having a surface facing said second table surface, said surface facing the second table surface being shaped so that the head ends of the basic conductors in the winding are maintained at a same height along the winding axis, and wherein the support surface is configured to be axially removed from the side of said second table surface before a rotation of the rotary table towards the insertion position into the stator pack.

17. An assembly and insertion process for assembling and inserting, into a stator pack a stater winding comprising one or more layers, each layer consisting of a circumferential arrangement of basic conductors, the basic conductors comprising a head end and one or more legs with a respective free end, the assembly and insertion process comprising:
a) providing an assembly and insertion system for assembling and inserting a winding into a stator pack comprising:
circumferential containment means of the basic conductors for assembling the winding, the circumferential containment means defining a set of spaces or slots configured to receive the legs of the basic conductors, an angular distance between two slots being referred to as a slot pitch;
removable insertion means for inserting the basic conductors into said circumferential containment means; and
rotating means for rotating the circumferential containment means about a winding axis, said rotating means being configured to perform rotations of one or more slot pitches about the winding axis;
the assembly and insertion system further comprising a rotary table with a first housing hole of the circumferential containment means, wherein the rotary table has a first table surface and a second table surface opposite to said first table surface;
the circumferential containment means are configured to receive said basic conductors starting from said free ends, on a side of said first table surface in an assembly position;
wherein
the rotary table is configured to rotate about a table axis so as to bring the circumferential containment means from the assembly position to an insertion position for insertion of the winding into the stator pack;
the assembly and insertion system further comprises feeding means of the stator pack from a side of said second table surface at the insertion position, said stator pack comprising a set of stator pack slots;
the assembly and insertion system further comprises relative introduction means for relative introduction of said winding into said stator pack in said insertion position; and wherein
the circumferential containment means comprise a set of positioners arranged circumferentially and configured to slide radially, wherein a space or slot of said set of spaces or slots is defined between each successive pair of positioners;
b) assembling the winding in the assembly position by the removable insertion means for inserting the basic conductors on the side of said first surface of the rotary table;
c) rotating the rotary table until the winding reaches the insertion position;
d) bringing the stator pack at said second table surface of the rotary table to the insertion position; and
e) introducing the winding into the stator pack with relative approaching motion between the winding and the stator pack.
